(19) United States
(12) Patent Application Publication
(10) Pub. No.: US 2015/0302336 A1
(43) Pub. Date: Oct. 22, 2015

(54) STRATEGIC PARTNER GOVERNANCE FRAMEWORK AND PERFORMANCE TRACKING

(71) Applicant: Bank of America Corporation, Charlotte, NC (US)

(72) Inventors: Mohit Dhingra, Opp Malaysian Township (IN); Mani Mohan Sitaraman, Gachibowli (IN)

(73) Assignee: Bank of America Corporation, Charlotte, NC (US)

(21) Appl. No.: 14/255,264

(22) Filed: Apr. 17, 2014

(51) Int. Cl. G06Q 10/06

(52) U.S. Cl. CPC G06Q 10/06393; G06Q 10/0635

(57) ABSTRACT

Systems, apparatus, methods, and computer program products are provided for managing the productivity and performance of a business' offsite service providers. Productivity is measured multi-dimensionally taking into account the unique business metrics that result in increased productivity. In addition, the framework herein provided can dynamically be adjusted over time at allow for different business metrics to be considered and/or assign a pre-determined level of importance to a business metric (i.e., proper weighting), resulting in a final productivity score that allows for comparison amongst service providers.

### FIELD

In general, embodiments of the invention relate to managing offsite service providers and, more particularly, providing a framework for overseeing and managing the performance of offsite service providers, otherwise referred to as vendors.

### BACKGROUND

Many businesses, such as enterprise-wide businesses have service providers that are located “offsite” (i.e., in locations in which the business itself does not have a physical presence). In such instances, in which the service providers are offsite, the ability to manage such suppliers becomes problematic because the business typically does not have a clear view of what factors affect productivity and what factors provide a basis for service provider improvement. In many instances, businesses lack oversight of offsite service providers because they possess no framework for understanding the key business metrics, otherwise referred to as key dimensions, which serve to measure the efficiency and success of the service provider's offsite output. Such lack of oversight results in an overall lack of control of the desired efficiency amongst service providers and unsatisfactory productivity levels from the offsite service providers.

Specifically, in many business environments, the business has minimal or no visibility into the different personnel factors that influence a service provider's performance, such as personnel attrition rates, the ability to timely on-board personnel, the effectiveness or utilization of personnel and the like. From a project delivery standpoint, unique business requirements may pose problems associated with monitoring service providers so as to assure minimal acceptable levels of performance and quality are assured for production projects, as well as developmental projects. In addition, many businesses do not possess a standardized mechanism to baseline or otherwise estimate or quantify future rework requirements (i.e., the degree of risk incurred by the business). Moreover, businesses may lack the proper operational oversight of service providers and a means to link productivity of the service providers to contractual obligations.

Therefore, a need exists to develop a systems, apparatus, computer program products and the like that provide a means for oversight of offsite service providers. The desired approach should readily define the factors (i.e., business metrics) that affect service provider productivity and measure the efficiency of the service provider's offsite output. Moreover, the desired approach should define business metrics in focus areas that impact service providers performance and productivity, such as personnel resourcing, project delivery, quality assurance, contractual compliance, risk incurred and operational oversight, so that the business can to gain an overall perspective on the service providers performance.

### SUMMARY OF THE INVENTION

The following presents a simplified summary of one or more embodiments in order to provide a basic understanding of such embodiments. This summary is not an extensive overview of all contemplated embodiments, and is intended to neither identify key or critical elements of all embodiments, nor delineate the scope of any or all embodiments. Its sole purpose is to present some concepts of one or more embodiments in a simplified form as a prelude to the more detailed description that is presented later.

Embodiments of the present invention address the above needs and/or achieve other advantages by providing apparatus, computer program products or the like that manage the productivity and performance of a business' (e.g., an enterprise-wide financial institution or the like) offsite service providers. Specifically, embodiments of the present invention provide for receiving business metrics from each of a business' offsite service provides that account for various focus areas, determining a percentage of adherence to a predetermined service level agreement or limit, categorizing each of the business metrics based on the percentage of adherence in terms of meeting a goal, requiring business action or invoking contractual obligations and determining a final performance score for each of the service providers.

An apparatus for a business to assess performance of offsite service providers defines first embodiments of the invention. The apparatus includes a computing platform having a memory and a processor in communication with the memory. The apparatus further includes a service provider assessment module that is stored in the memory and executable by the processor. The service provider assessment module is configured to receive business metric data from a plurality of offsite service providers that provide a service for the business. The business metric data covers a previous predetermined time period and includes business metrics associated with (1) personnel resourcing, (2) project delivery, (3) quality of service provided, (4) contract compliance, (5) potential risk and (6) operational oversight. The module is further configured to determine, for each service provider and for each business metric, a percentage of adherence to one of a predetermined service level agreement or a predetermined limit and determine that the percentage of adherence falls within one of (1) a goal category, (2) a trigger category and (3) a limit category. The goal category defines an acceptable level of adherence, the trigger category results in action on behalf of the business and the limit category results in contractual obligations. Further, the module is configured to determine, for each service provider, a final performance score for the predetermined time period based on the percentage of adherence for each business metric.

In specific embodiments of the apparatus, the module is configured to receive business metric data that includes business metrics associated with personnel resourcing. The business metrics associated with personnel resourcing include one or more of (1) amount of personnel attrition occurring over the predetermined time period, (2) amount of time to hire personnel for open positions, (3) shadow personnel resources available for identified critical personnel resources and (4) actual billing time of service provider personnel in comparison to budgeted time.

In other specific embodiments of the apparatus, the module is configured to receive business metric data that includes business metrics associated with project delivery. The project delivery metrics may be associated with (1) development projects, (2) project quality assurance and (3) implemented/delivered projects. In such embodiments of the apparatus, the business metrics associated with development projects may include amount of projects that have been released into production without defects or issues occurring prior to release into production. In other such embodiments of the apparatus, the business metrics associated with quality assurance include one or more of (1) overall quality assurance effectiveness, (2) defects, based on defect priority, in production, (3) defects deferred to future releases, (4) defect acceptance rate and (5) coverage in regression testing. While in still further such embodiments of the apparatus, the business metrics associated with implemented projects include one or more of (1) successful remedial actions in comparison to all remedial actions implemented, (2) incident response time, (3) incident recovery based on defect priority, and (4) problem resolution time.

Moreover, in other specific embodiments of the apparatus, the module is configured to receive business metric data that includes business metrics associated with quality assurance. The business metrics associated with quality assurance may include one or more of (1) quality of software code and (2) experience of personnel resources. In other embodiments of the apparatus, the module is configured to receive business metric data that includes business metrics associated with contract compliance. In such embodiments the business metrics associated with contract compliance may include one or more of (1) compliance to attrition contractual requirements, (2) ratio of onsite versus offsite personnel resources and (3) compliance with on-boarding and off-boarding contractual requirements.

In still further embodiments of the apparatus, the module is configured to receive business metric data that includes business metrics associated with potential risk to the business. In such embodiments, the business risks associated with potential risk may include one or more of (1) cost of rework estimated to be performed on defects by the business and (2) amount of time estimated to be performed on defects by the business. In other related embodiments of the apparatus, the module is configured to receive business metric data that includes business metrics associated with operational oversight. In such embodiments of the apparatus, the business metrics associated with operational oversight may include one or more of (1) reporting compliance and (2) timeliness addressing open issues.

A method for a business to assess performance of offsite service providers defines second embodiments of the invention. The method includes receiving business metric data from a plurality of offsite service providers that provide a service for the business. The business metric data covers a previous predetermined time period and includes business metrics associated with (1) personnel resourcing, (2) project delivery, (3) quality of service provided, (4) contract compliance, (5) potential risk and (6) operational oversight. The method further includes determining, for each service provider and for each business metric, a percentage of adherence to one of a predetermined service level agreement or a predetermined limit and determining, for each service provider and for each business metric, that the percentage of adherence falls within one of a goal category, a trigger category and a limit category. The goal category defines an acceptable level of adherence, the trigger category results in action on behalf of the business and the limit category results in contractual obligations. The method further includes determining, for each service provider, a final performance score for the predetermined time period based on the percentage of adherence for each business metric.

In specific embodiments of the method, receiving business metric data further includes receiving the business metric data that includes the business metrics associated with personnel resourcing. The business metrics associated with personnel resourcing include one or more of (1) amount of personnel attrition occurring over the predetermined time period, (2) amount of time to hire personnel for open positions, (3) shadow personnel resources available for identified critical personnel resources and (4) actual billing time of service provider personnel in comparison to budgeted time.

In other specific embodiments of the method, receiving business metric data further includes receiving the business metric data that includes the business metrics associated with project delivery. The business metrics associated with project delivery include one or more of (1) amount of projects that have been released into production without and defects or issues occurring prior to release into production, (2) overall quality assurance effectiveness, (3) defects, based on defect priority, in production, (4) defects deferred to future releases, (5) defect acceptance rate, (6) coverage in regression testing, (7) successful remedial actions in comparison to all remedial actions implemented, (8) incident response time, (9) incident recovery based on defect priority, and (10) problem resolution time.

In still further specific embodiments of the method, receiving business metric data further includes receiving the business metric data that includes the business metrics associated with quality of service and contract compliance. The business metrics associated with quality of service may include one or more of (1) quality of software code and (2) experience of personnel resources and the business metrics associated with contract compliance may include one or more of (1) compliance to attrition contractual requirements, (2) ratio of onsite versus offsite personnel resources and (3) compliance with on-boarding and off-boarding contractual requirements.

Moreover, in other specific embodiments of the method, receiving business metric data further includes receiving the business metric data that includes the business metrics associated with potential risk and operational oversight. The business metrics associated with potential risk may include at least one of (1) cost of rework estimated to be performed on defects by the business and (2) amount of time estimated to be performed on defects by the business and the business metrics associated with operational oversight may include at least one of (1) reporting compliance and (2) timeliness addressing open issues.

A computer program product including a non-transitory computer-readable medium defines third embodiments of the invention. The computer-readable medium includes a first set of codes for causing a computing device processor to receive business metric data from a plurality of offsite service providers that provide a service for the business. The business metric data covers a previous predetermined time period and includes business metrics associated with (1) personnel resourcing, (2) project delivery, (3) quality of service provided, (4) contract compliance, (5) potential risk and (6) operational oversight. The computer-readable medium additionally includes a second set of codes for causing a computing device processor to determine, for each service provider and for each business metric, a percentage of adherence to one of a predetermined service level agreement or a predetermined limit. Additionally, the computer-readable medium includes a third set of codes for causing a computing device processor to determine, for each service provider and for each business metric, that the percentage of adherence falls within one of a goal category, a trigger category and a limit category. The goal category defines an acceptable level of adherence, the trigger category results in action on behalf of the business and the limit category results in contractual obligations. Moreover, the computer-readable medium includes a fourth set of codes for causing a computing device processor to determine, for each service provider, a final performance score for the predetermined time period based on the percentage of adherence for each business metric.

Thus, systems, apparatus, methods, and computer program products herein described in detail below provide for managing the productivity and performance of a business' (e.g., an enterprise-wide financial institution or the like) offsite service providers. Productivity is measured multi-dimensionally taking into account the unique business metrics that result in increased productivity. In addition, the framework herein provided can dynamically be adjusted over time at allow for different business metrics to be considered and/or assign a pre-determined level of importance to a business metric (i.e., proper weighting), resulting in a final productivity score that allows for comparison amongst service providers.

To the accomplishment of the foregoing and related ends, the one or more embodiments comprise the features hereinafter fully described and particularly pointed out in the claims. The following description and the annexed drawings set forth in detail certain illustrative features of the one or more embodiments. These features are indicative, however, of but a few of the various ways in which the principles of various embodiments may be employed, and this description is intended to include all such embodiments and their equivalents.

### BRIEF DESCRIPTION OF THE DRAWINGS

Having thus described embodiments of the invention in general terms, reference will now be made to the accompanying drawings, which are not necessarily drawn to scale, and wherein:

FIG. 1 provides a block diagram of an apparatus configured to provide management of productivity and performance of offsite service providers, in accordance with embodiments of the present invention;

FIG. 2 provides a more detailed block diagram of a service provider assessment module highlighting various business metrics that may be assessed for offsite service providers, in accordance with present embodiments of the invention;

FIG. 3 provides a flow diagram of a method for managing offsite service provide productivity and performance, in accordance with present embodiments of the invention; and

FIG. 4 provides another flow diagram of a method for managing offsite service provide productivity and performance in accordance with present embodiments of the invention.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Like numbers refer to like elements throughout. Although some embodiments of the invention described herein are generally described as involving a “financial institution,” one of ordinary skill in the art will appreciate that the invention may be utilized by other businesses that take the place of or work in conjunction with financial institutions to perform one or more of the processes or steps described herein as being performed by a financial institution.

As will be appreciated by one of skill in the art in view of this disclosure, the present invention may be embodied as an apparatus (e.g., a system, computer program product, and/or other device), a method, or a combination of the foregoing. Accordingly, embodiments of the present invention may take the form of an entirely hardware embodiment, an entirely software embodiment (including firmware, resident software, micro-code, etc.), or an embodiment combining software and hardware aspects that may generally be referred to herein as a “system.” Furthermore, embodiments of the present invention may take the form of a computer program product comprising a computer-usable storage medium having computer-usable program code/computer-readable instructions embodied in the medium.

Any suitable computer-usable or computer-readable medium may be utilized. The computer usable or computer readable medium may be, for example but not limited to, an electronic, magnetic, optical, electromagnetic, infrared, or semiconductor system, apparatus, or device. More specific examples (e.g., a non-exhaustive list) of the computer-readable medium would include the following: an electrical connection having one or more wires; a tangible medium such as a portable computer diskette, a hard disk, a time-dependent access memory (RAM), a read-only memory (ROM), an erasable programmable read-only memory (EPROM or Flash memory), a compact disc read-only memory (CD-ROM), or other tangible optical or magnetic storage device.

Computer program code/computer-readable instructions for carrying out operations of embodiments of the present invention may be written in an object oriented, scripted or unscripted programming language such as Java, Perl, Smalltalk, C++ or the like. However, the computer program code/computer-readable instructions for carrying out operations of the invention may also be written in conventional procedural programming languages, such as the “C” programming language or similar programming languages.

Embodiments of the present invention are described below with reference to flowchart illustrations and/or block diagrams of methods or apparatuses (the term “apparatus” including systems and computer program products). It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a particular machine, such that the instructions, which execute by the processor of the computer or other programmable data processing apparatus, create mechanisms for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer readable memory produce an article of manufacture including instructions, which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions, which execute on the computer or other programmable apparatus, provide steps for implementing the functions/acts specified in the flowchart and/or block diagram block or blocks. Alternatively, computer program implemented steps or acts may be combined with operator or human implemented steps or acts in order to carry out an embodiment of the invention.

According to embodiments of the invention described herein, various systems, apparatus, methods, and computer program products are herein described for managing the productivity and performance of a business' (e.g., an enterprise-wide financial institution or the like) offsite service providers. Offsite service providers are defined as those service providers located in locations in which the business itself does not have a physical presence. Productivity is measured multi-dimensionally taking into account the unique business metrics that result in increased productivity. In addition, the framework herein provided can dynamically be adjusted over time at allow for different business metrics to be considered and/or assign a pre-determined level of importance to a business metric (i.e., proper weighting), resulting in a final productivity score that allows for comparison amongst service providers. Specifically, embodiments of the present invention provide for receiving business metrics from each of a business' offsite service provides that account for various focus areas, determining a percentage of adherence to a predetermined service level agreement or limit, categorizing each of the business metrics based on the percentage of adherence in terms of meeting a goal, requiring business action or invoking contractual obligations and determining a final performance score for each of the service providers.

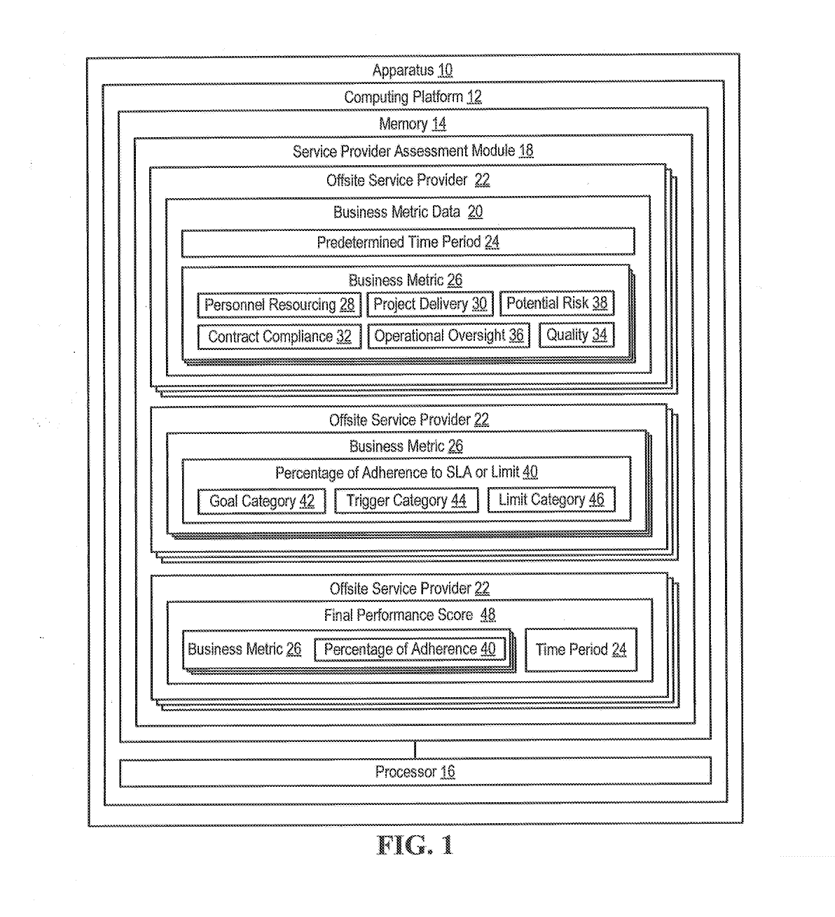

Referring to FIG. 1, a block diagram is presented of an apparatus 10 configured for providing managing the productivity and performance of a business' offsite service providers, in accordance with embodiments of the invention. The apparatus includes a computing platform 12 having a memory 14 and at least one processor 16 in communication with the memory 14. The apparatus 10 may include any type and/or combination of one or more computing devices. The apparatus 10 is operable to receive and execute modules, routines and applications, such as service provider assessment module 18 and the like.

The apparatus 10 includes computing platform 12 that can receive and execute routines and applications. Computing platform 12 includes memory 14, which may comprise volatile and nonvolatile memory such as read-only and/or random-access memory (RAM and ROM), EPROM, EEPROM, flash cards, or any memory common to computer platforms. Further, memory 14 may include one or more flash memory cells, or may be any secondary or tertiary storage device, such as magnetic media, optical media, tape, or soft or hard disk.

Further, computing platform 12 also includes at least one processor 16, which may be an application-specific integrated circuit (“ASIC”), or other chipset, processor, logic circuit, or other data processing device. Processor 16 or other processor such as ASIC may execute an application programming interface (“API”) layer (not shown in FIG. 1) that interfaces with any resident programs, such as service provider assessment module 18 or the like, stored in the memory 14 of apparatus 10. Processor 16 includes various processing subsystems (not shown in FIG. 1) embodied in hardware, firmware, software, and combinations thereof, that enable the functionality of apparatus 10 and the operability of the apparatus on a network. For example, processing subsystems allow for initiating and maintaining communications, and exchanging data, with other networked devices. Additionally, processing subsystems may include any portion of the functionality of service provider assessment module 18 obviating the need for such applications and modules to be stored in the memory.

As previously noted, the memory 14 of apparatus 10 stores service provider assessment module 18 that is implemented to assess or otherwise manage the productivity and performance of a business' offsite service providers. In this regard, the service provider assessment module 18 is configured to receive business metric data 20 from a plurality of offsite service providers 22. The service providers 22 may provide a service and/or a product to a business, such as, for example, an enterprise-wide financial institution or the like. For example, the service provider 22 may provide the business with a specific software application or the like. In specific embodiment, the business metric data 20 may be received from all of the offsite service providers 22 providing a service to the business, while in other embodiments business metric data 20 may be received from select predetermined service providers 22. The business metric data 20 that is received and subsequently used to determine the service provider's productivity and performance will cover a predetermined previous time period 24, e.g., previous 30-days/month period, previous 60-days, previous 90-days or the like. The time period 24 over which the received business metrics cover will coincide with the time period over which determinations are made as to the levels of adherence to service level agreements (SLAs), thresholds/limits and the like and final performance scores for the service provider. As such, the business metric data 20 may be received at the conclusion of the predetermined time period 24 and/or periodically throughout the predetermined time period 24.

In specific embodiments of the invention the business metric data 20 that is received includes business metrics 26 associated with one or more of personnel resourcing 28, project delivery 30, contract compliance 32, quality assurance 34, operational oversight 36 and potential risk to the business 38.

Personnel resourcing 28 includes business metrics 26/dimensions associated with attrition, time to hire and/or onboard, utilization of personnel in the business' projects and the backup resources personnel required for critical positions/functions. The service providers should demonstrate the ability to rebalance efforts through resource/personnel reallocation (i.e., identify skills of personnel/resources for the purpose of effectively implementing reallocation).

Project delivery 30 includes business metrics 26 that measure the actual functionality delivered to the business by aligning the demand model to the cost structure of the project. Project delivery 30 business metrics take into account both developmental projects, as well as production/support projects. Further, project delivery 30 business metrics 26 should identify the functionality that is worked by the service provider but not delivered to the business (i.e., identify the cost of non-salvageable services/products) and seek to avoid such.

Contract compliance 32 business metrics 26 serve to measure the service provider's ability to comply with specific clauses in the contracts, such as attrition clauses, onboarding and off-boarding clauses and the like, and the ratio of onsite versus offshore personnel. Further contract compliance 32 business metrics 26 serve to identify opportunities to improve efficiency by identifying contracts that can be consolidated, documenting rework, technical issues and the like.

Quality assurance 34 business metrics 26 measure the cost of quality during the execution of a project by measuring the defects per functionality, (e.g., code quality for information technology projects). In addition, business metrics 26 associated with quality assurance 34 measure the adherence to service level agreements related to level of experience of resources/personnel.

Operational oversight 36 business metrics 26 ensure mechanisms are in place to correct inadequate performance. In this regard, business metrics 26 associated with operational oversight 36 ensure proper reporting is in place and that time around time for open issues is minimalized.

Potential risk 38 business metrics 26 serve to measure the risk to the business based on the amount and of rework performed and the estimation of the effort for the rework by the service provider.

Once the business metric data 20 has been received, the service provider assessment module 18 is configured to apply a customized formula/algorithm to determine, for each service provider 22 and each one of the business metrics 26, a percentage of adherence 40 to one of a service level agreement (SLA) or a predetermined limit/threshold.

Once the percentage of adherence 40 to the SLA or limit/threshold is determined, the percentage of adherence 40 is categorized into one of three categories; a goal category 42, a trigger category 44 or a limit category 46. The limits that define a category may be predefined and may change over time as circumstances dictate. The goal category 42 signifies an acceptable level of adherence 40 to the SLA or limit/threshold in which no action needs to be undertaken by the business and/or the service provider. The trigger category 44 is defined by action on behalf of the business, for example, notification of management within the business and/or service provider or some other form of corrective action. The limit category 46 is defined by a contractual obligation, for example, a financial retribution or the like may be invoked based the service provider not meeting the requisite SLA/limit (i.e., falling within the limit category).

Once the percentage of adherence 40 and the categorizations are determined for each business metric, the service provider assessment module is further configured to determine a final performance score 48 for each of the service providers 22 over the predetermined period time 24 based on the percentage of adherence 40 for each of the business metrics 26. In specific embodiments the final performance score 48 may take into account the level of importance of each of the business metrics 26 by implementing a weighting system, whereby more significant/important business metrics are imparted greater weight and less significant/important business metrics are imparted less weight. In other specific embodiments of the invention, the final performance score 48 is derived by the number of business metrics associated with the service provider that fall outside of the goal category 42 (i.e., the number of business metrics 26 in the trigger category 44 and limit category 46).

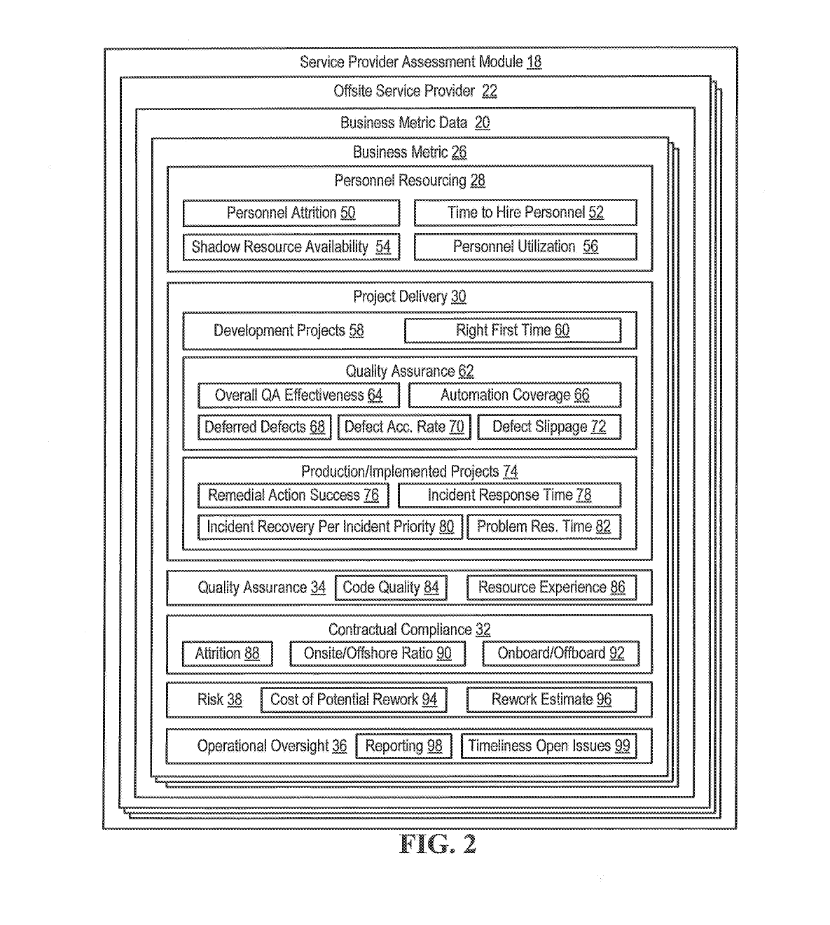

Referring to FIG. 2, a block diagram is presented of the service provider assessment module 18 highlighting various business metrics 26 that may be used to assess the performance and productivity of offsite service providers 22, in accordance with specific embodiments of the present invention. It should be noted that the business metrics 26 shown and described in relation to FIG. 2 are by way of example only and, as such other business metrics may be used to assess the performance and productivity of offsite service providers as dictated by the business implementing the module 18.

As previously noted in relation to FIG. 1, memory 14 of apparatus 10 stores service provider assessment module 18 that is configured to assess, or otherwise manage, the productivity and performance of a business' offsite service providers. In this regard, the service provider assessment module 18 is configured to receive business metric data 20 from a plurality of offsite service providers 22. In specific embodiments of the invention the business metric data 20 that is received includes business metrics 26 associated with one or more of personnel resourcing 28, project delivery 30, contract compliance 32, quality assurance 34, operational oversight 36 and potential risk to the business 38.

Business metrics 26 associated with personnel resourcing 28 may include personnel attrition 50, time-to-hire personnel 52, shadow resource availability 54 and personnel utilization 56. In specific embodiments of the invention the personnel attrition 50, time-to-hire personnel 52, shadow resource availability 54 and personnel utilization 56 are tied to service level agreements (SLA). In one specific embodiment, the SLA for personnel/resource attrition 50 may be configured such that the service provider agrees to provide personnel at a discount for a prescribed period of time (e.g., free of charge for thirty days) in the event of unplanned attrition. Planned attrition is one of (1) three month notification by the business with adequate replacement trained and ready, (2) appropriate shadow resource/personnel utilized to replace the attrition, or (3) any resource/personnel change mutually agreed upon by the business and the service provider. Any attrition that is not “planned” is deemed unplanned attrition. In another specific embodiment, the SLA for the time-to-hire 52 provides for the service provider to identify and on-board an open or back-fill position within a prescribed period of time. In a further specific embodiment, the SLA for the shadow resource 54 provides for the service provider to have, for all identified personnel/resources deemed to be “critical”, a shadow resource available that can take the place of the critical personnel in the event the critical personal leaves or is otherwise unavailable. Moreover, in yet another specific embodiment, the SLA for the utilization 56 is defined by the actual billing hours of the personnel/resource in comparison to the budgeted (i.e., estimated) billing hours for the personnel/resource. In certain instances, actual billing hours may be less than the budgeted billing hours and may be a cause for concern by the business employing the service provider.

Business metrics 26 associated with project delivery 30 may include right-first-time 60 associated with developmental projects 58. In specific embodiments of the invention the right-first-time 60 is tied to a service level agreement (SLA). The SLA for right-first-time 60 requires that the service or products be delivered correctly (i.e., per specification) when it is delivered by the service provider for the first time (i.e., during the developmental stage of the project).

Other business metrics 26 associated with project delivery 30 are tied to quality assurance 62 and may include overall Quality Assurance (QA) effectiveness 64, automation coverage 66, deferred defects 68, defect acceptance rate 70 and defect slippage to production based severity level of the defect 72. The percentage of adherence 40 for these business metrics (64, 66, 68, 70 and 72) are determined based on application of predetermined formulas. Overall QA effectiveness 64 may be defined by the defects found prior to production (e.g., during System Integration Testing (SIT)) in comparison to all of the defects associated with a project (i.e., prior to production (SIT), user acceptance testing (UAT), pre-production and production). Defect slippage to production 72 may be categorized based on the severity of the defect and may be defined as the defects of a specified severity level that made into production in comparison to all of the defects associated with the project (i.e., prior to production, User Acceptance Testing (UAT), pre-production and production). Deferred defects 68 may be defined by the defects prior to production/SIT deferred to future releases of the product/service in comparison to the total volume of defects prior to production/SIT. Defect acceptance rate 70 may be defined by the defects prior to production/SIT that were accepted in comparison to the total volume of defects prior to production/SIT. Automation coverage 66 may be defined by the coverage in regression testing (i.e., the number of scripts/processes automated in comparison to the total number of scripts/processes).

Still further business metrics 26 associated with project delivery 30 are tied to production/implemented projects 74 and may include remedial action success 76, incident response time 78, incident recovery based on the priority category of the incident 80, and problem resolution time 82. The percentage of adherence 40 for these business metrics (76, 78, 80 and 82) are determined based on application of predetermined formulas. Remedial action success 76 is defined as successful remedial actions (i.e., changes) implemented in comparison to the overall volume of remedial actions (i.e., changes) implemented. Incident response time 78 may be defined as the total volume of requests responded within a predetermined time period (which may be SLA-defined) in comparison to the total volume of requests responded. Incident recovery 80 may be categorized based on the priority of the incident and is defined as the total number of incidents in the priority category in comparison to the volume of tickets recovered within a predefined SLA in comparison to the total number of incidents in the priority category. Problem resolution time 82 may be defined as the volume of problem tickets resolved within a predetermined time period (which may be SLA-defined) in comparison to the total volume of problem tickets resolved.

Business metrics 26 associated with quality assurance 34 may include code quality 84 and resource experience 86. Resource experience is defined as the total years of experience in the skills required for a project that a service provider has allocated to a project. The percentage of adherence 40 for code quality 84 may be determined based on the volume of user requirements which had defects in a release versus the total number of user requirements in a release. The percentage of adherence 40 for resource experience 86 may be based on a predetermined SLA.

Business metrics 26 associated with contract compliance 32 may include compliance to attrition clause 88, onsite versus offshore ratio 90 and compliance to onboard/off-board compliance 92. The percentage of adherence 40 for compliance to attrition 88 and onboard/off-board 92 may be determined based on a predetermined SLA and for onsite versus offshore ratio 90 based on application of a predetermined formula and for resource experience based. In specific embodiments, the SLA for attrition compliance 88 requires that, in the event of unplanned attrition, the service provider shall provide resources at a discount for a predetermined period of time (e.g., free of charge for a month or the like). In other specific embodiments, the SLA for onboard/off-board compliance 92 may be based on the ability of the service provider to onboard and/or off-board personnel within a predetermined time period. In further specific embodiments, the onsite versus offshore ratio 90 is defined as ratio of the volume of personnel/resources working onsite as compared to the total volume of personnel/resources versus the volume of personnel/resources located offshore as compared to the total volume of personnel/resources.

Business metrics 26 associated with risk 38 may include a rework cost estimated 94 and the effort required for the estimated rework 96. Rework as used herein is the effort in terms of person-hours required to correct the defect. The percentage of adherence 40 for effort for the estimated rework may be based on the time taken to correct a repair multiplied by the total number of person-hours spent on correcting the defect. The percentage of adherence 40 for rework cost estimated 94 may be determined based on a predetermined SLA.

Business metrics 26 associated with operational oversight 36 may include reporting 98 and turnaround time for open issues 99. The percentage of adherence 40 for reporting 98 may be determined based on a predetermined SLA and for turnaround time for open issues 99 based on the difference between the time the issue was logged into the system of record and the time the issue was closed.

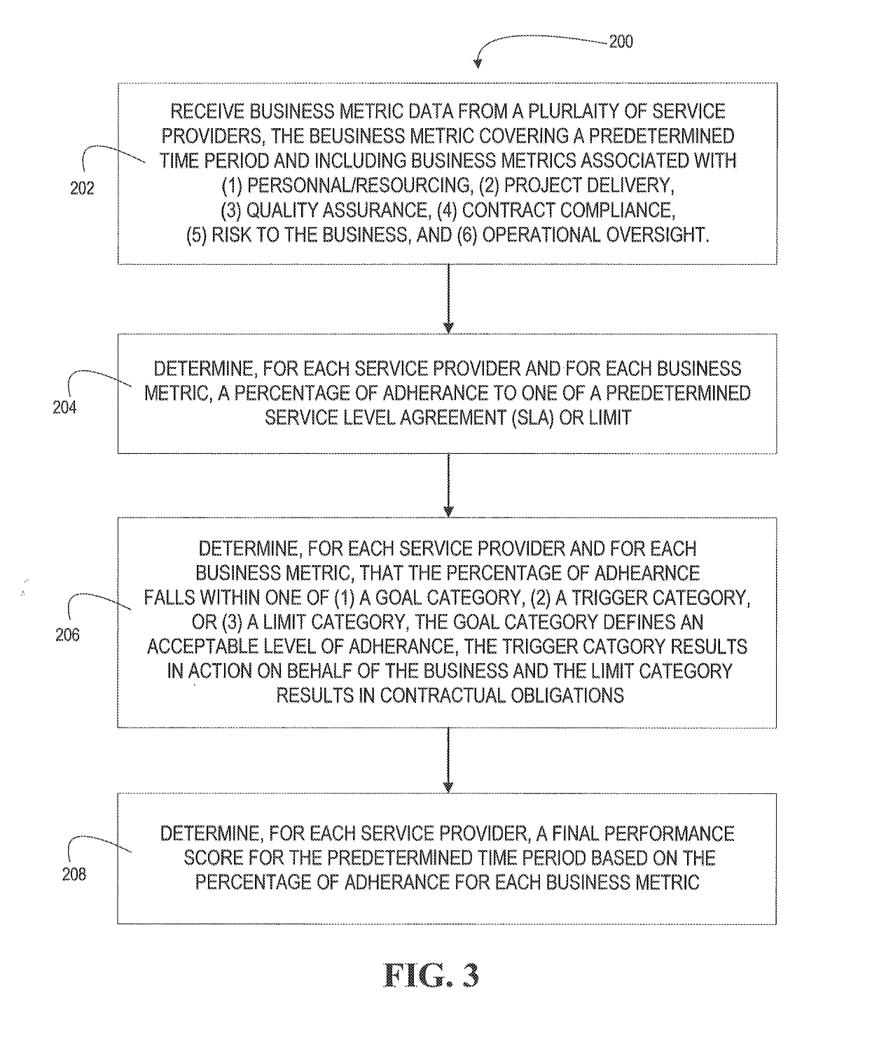

Referring to FIG. 3, a high-level flow diagram is presented of a method 200 for managing or assessing the productivity and performance of a business' offsite service providers, in accordance with embodiments of the present invention. At Event 202, business metric data is received from a plurality of offsite service providers. Offsite service providers are defined as service providers located in locations in which the business itself does not have physical locations (in other words, service providers are located in locations that are not readily accessible to the business (e.g., require air travel to visit)). The raw business metric data that is received may be properly formatted or may require formatting to allow for necessary downstream processing. The business metric data may be received at the end of a predetermined time period or may be received periodically throughout the predetermined time period and stored for subsequent processing after the conclusion of the time period. The business metric data that is received includes business metrics associated with (1) personnel/resourcing, (2) project delivery, (3) quality assurance, (4) contract compliance (5) risk to the business, and (6) operational oversight.

At Event 204, for each business metric and for each of the service providers, a percentage of adherence to one of a predetermined Service Level Agreement (SLA) or a limit/threshold is determined. In specific instance, a predetermined formula is applied to determine the percentage of adherence to the SLA or limit/threshold. In specific embodiments, the percentage of adherence determinations are conducted on a predetermined scheduled basis, such as monthly, quarterly, and/or annually or the like.

At Event 206, each business metric and for each of the service providers, a level of adherence category is determined from amongst a plurality of categories. In specific embodiments three categories are provided, for example, (1) a goal category, (2) a trigger category, and (3) a limit category. The goal category signifies an acceptable level of adherence for the service provider and requires no action on behalf of the business and/or service provider. The trigger category is defined by an action on behalf of the business and/or service provider. The action may include notification to the service provider that the level of adherence has reached the trigger category/level and/or notification to identified personnel (e.g., management) within the business that the level of adherence has reached the trigger category/level. In addition, the action may include corrective action or the like required of the service provider. The limit category is defined by contractual obligations placed on the service provider. For example, the contractual obligations may include financial offsets or the like imposed based on the service provider's failure to adhere to less than the threshold set by the limit category. It should be noted that the limits/thresholds/ranges associated with any given level of adherence category may change over time depending on the needs of the business and may vary from service provider-to-service provider as dictated by the business. In addition, to contractual obligations, the limit category may require further notifications within the business and/or further corrective actions by the service provider.

At Event 208, a final performance score is determined for each of the service providers covering the predetermined time period. The final performance score may be based on the percentage of adherence for each of the business metrics. In addition, a weighting scheme may be implemented to determine the final performance score, whereby more important business metrics (as deemed by the business) are afforded greater weight and less important business metrics are afforded less weight. In specific embodiments of the invention, the final performance score may be based on the number of business metrics that fall into each of the level of adherence categories.

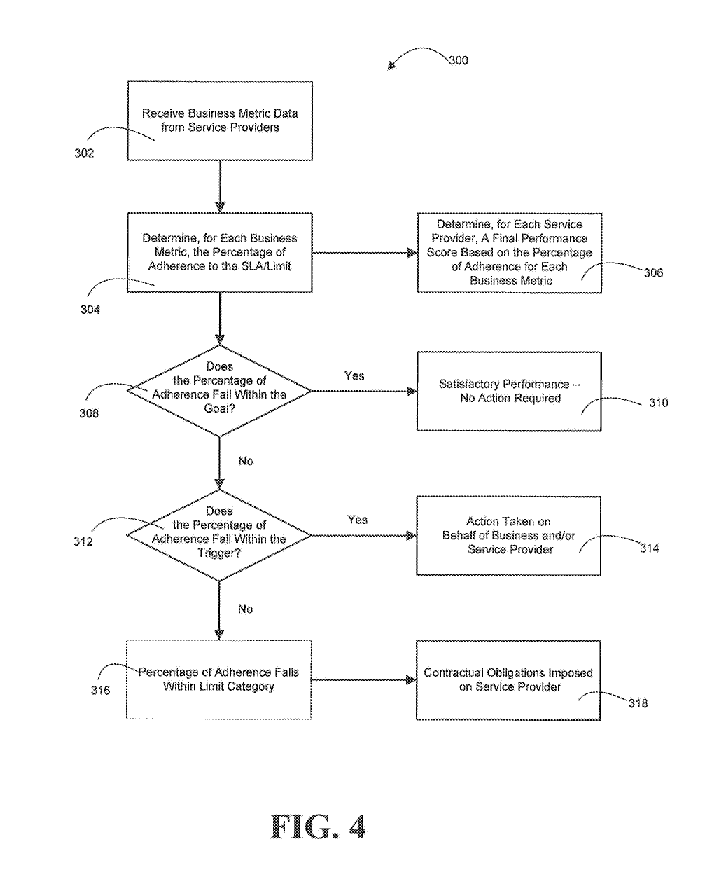

FIG. 4 provides a flow diagram of alternate method 300 for managing or assessing the productivity and performance of a business' offsite service providers, in accordance with embodiments of the present invention. At Event 302, business metric data is received from a plurality of offsite service providers and covers a predetermined time period. The business metric data that is received includes business metrics associated with (1) personnel/resourcing, (2) project delivery, (3) quality assurance, (4) contract compliance (5) risk to the business, and (6) operational oversight.

At Event 304, for each business metric and for each of the service providers, a percentage of adherence to one of a predetermined Service Level Agreement (SLA) or a limit/threshold is determined. In specific instance, a predetermined formula is applied to determine the percentage of adherence to the SLA or limit/threshold. At Event 306, a final performance score is determined for each of the service providers covering the predetermined time period. The final performance score may be based on the percentage of adherence for each of the business metrics. As such, according to some embodiments of the invention, the final performance score may be determined prior to determining a level of adherence category for each of the business metrics or may be determined concurrently with the determination of the level of adherence categories. While in other embodiments of the invention, in which the final performance score is based, at least in part, on the level of adherence categorization, the final performance score is determined after completion of the determination of the level of adherence category.

At Decision 308, a determination is made as to whether the percentage of adherence for a given business metric falls within a predetermined goal category. If the level of adherence is determined to fall within the goal category, at Event 310, the business metric is deemed to be satisfactory and no further actions are required by the business and/or service provider.

If the determination is made that the level of adherence is outside of the limit/threshold set by the goal category, at Decision 312, a determination is made as to whether the percentage of adherence falls within a predetermined trigger category. If the level of adherence is determined to fall within the trigger category, at Event 314, an action, such as notification and/or corrective action, is taken on behalf of the business and/or service provider.

If the determination is made that the level of adherence is outside of the limit/threshold set by the trigger category, at Event 316, the percentage of adherence is deemed to fall within a predetermined limit category and, at Event 318, in addition to further action being taken by the business and/or service provider, contractual obligations are enforced against the service provider, such financial offsets or the like.

Thus, systems, apparatus, methods, and computer program products described above provide for managing the productivity and performance of a business' (e.g., an enterprise-wide financial institution or the like) offsite service providers. Offsite service providers are defined as those service providers located in locations in which the business itself does not have a physical presence. Productivity is measured multi-dimensionally taking into account the unique business metrics that result in increased productivity. In addition, the framework herein provided can dynamically be adjusted over time at allow for different business metrics to be considered and/or assign a pre-determined level of importance to a business metric (i.e., proper weighting), resulting in a final productivity score that allows for comparison amongst service providers.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other changes, combinations, omissions, modifications and substitutions, in addition to those set forth in the above paragraphs, are possible.

Those skilled in the art may appreciate that various adaptations and modifications of the just described embodiments can be configured without departing from the scope and spirit of the invention. Therefore, it is to be understood that, within the scope of the appended claims, the invention may be practiced other than as specifically described herein.

What is claimed is:

1. An apparatus for a business to assess performance of offsite service providers, the apparatus comprising:
a computing platform including a memory and a processor in communication with the memory; and
a service provider assessment module stored in the memory, executable by the processor and configured to:
receive business metric data from a plurality of offsite service providers that provide a service for the business, wherein the business metric data covers a previous predetermined time period and includes business metrics associated with (1) personnel resourcing, (2) project delivery, (3) quality of service provided, (4) contract compliance, (5) potential risk and (6) operational oversight,
for each service provider and for each business metric, determine a percentage of adherence to one of a predetermined service level agreement or a predetermined limit,
for each service provider and for each business metric, determine that the percentage of adherence falls within one of a goal category, a trigger category and a limit category, wherein the goal category defines an acceptable level of adherence, the trigger category results in action on behalf of the business and the limit category results in contractual obligations, and
for each service provider, determine a final performance score for the predetermined time period based on the percentage of adherence for each business metric.

2. The apparatus of claim 1, wherein the business metrics associated with personnel resourcing include one or more of (1) amount of personnel attrition occurring over the predetermined time period, (2) amount of time to hire personnel for open positions, (3) shadow personnel resources available for identified critical personnel resources and (4) actual billing time of service provider personnel in comparison to budgeted time.

3. The apparatus of claim 1, wherein the business metrics associated with project delivery include metrics associated with (1) development projects, (2) quality assurance, and (3) implemented projects.

4. The apparatus of claim 3, wherein the business metrics associated with development projects include amount of projects that have been released into production without defects or issues occurring prior to release into production.

5. The apparatus of claim 3, wherein the business metrics associated with quality assurance include one or more of (1) overall quality assurance effectiveness, (2) defects, based on defect priority, in production, (3) defects deferred to future releases, (4) defect acceptance rate and (5) coverage in regression testing.

6. The apparatus of claim 3, wherein the business metrics associated with implemented projects include one or more of (1) successful remedial actions in comparison to all remedial actions implemented, (2) incident response time, (3) incident recovery based on defect priority, and (4) problem resolution time.

7. The apparatus of claim 1, wherein the business metrics associated with quality of service include one or more of (1) quality of software code and (2) experience of personnel resources.

8. The apparatus of claim 1, wherein the business metrics associated with contract compliance include one or more of (1) compliance to attrition contractual requirements, (2) ratio of onsite versus offsite personnel resources and (3) compliance with on-boarding and off-boarding contractual requirements.

9. The apparatus of claim 1, wherein the business metrics associated with potential risk include one or more of (1) cost of rework estimated to be performed on defects by the business and (2) amount of time estimated to be performed on defects by the business.

10. The apparatus of claim 1, wherein the business metrics associated with operational oversight include one or more of (1) reporting compliance and (2) timeliness addressing open issues.

11. A method for a business to assess performance of offsite service providers, the method comprising:
receiving, by a computing device processor, business metric data from a plurality of offsite service providers that provide a service for the business, wherein the business metric data covers a previous predetermined time period and includes business metrics associated with (1) personnel resourcing, (2) project delivery, (3) quality of service provided, (4) contract compliance, (5) potential risk and (6) operational oversight;
for each service provider and for each business metric, determining, by a computing device processor, a percentage of adherence to one of a predetermined service level agreement or a predetermined limit;
for each service provider and for each business metric, determining, by a computing device processor, that the percentage of adherence falls within one of a goal category, a trigger category and a limit category, wherein the goal category defines an acceptable level of adherence, the trigger category results in action on behalf of the business and the limit category results in contractual obligations; and
for each service provider, determining, by a computing device processor, a final performance score for the predetermined time period based on the percentage of adherence for each business metric.

12. The method of claim 11, wherein receiving business metric data further comprises receiving the business metric data that includes the business metrics associated with personnel resourcing, wherein the business metrics associated with personnel resourcing include one or more of (1) amount of personnel attrition occurring over the predetermined time period, (2) amount of time to hire personnel for open positions, (3) shadow personnel resources available for identified critical personnel resources and (4) actual billing time of service provider personnel in comparison to budgeted time.

13. The method of claim 11, wherein receiving business metric data further comprises receiving the business metric data that includes the business metrics associated with project delivery, wherein the business metrics associated with project delivery include one or more of (1) amount of projects that have been released into production without defects or issues occurring prior to release into production, (2) overall quality assurance effectiveness, (3) defects, based on defect priority, in production, (4) defects deferred to future releases, (5) defect acceptance rate, (6) coverage in regression testing, (7) successful remedial actions in comparison to all remedial actions implemented, (8) incident response time, (9) incident recovery based on defect priority, and (10) problem resolution time.

14. The method of claim 11, wherein receiving business metric data further comprises receiving the business metric data that includes the business metrics associated with quality of service and contract compliance, wherein the business metrics associated with quality of service include one or more of (1) quality of software code and (2) experience of personnel resources and wherein the business metrics associated with contract compliance include one or more of (1) compliance to attrition contractual requirements, (2) ratio of onsite versus offsite personnel resources and (3) compliance with on-boarding and off-boarding contractual requirements.

15. The method of claim 11, wherein receiving business metric data further comprises receiving the business metric data that includes the business metrics associated with potential risk and operational oversight, wherein the business metrics associated with potential risk include at least one of (1) cost of rework estimated to be performed on defects by the business and (2) amount of time estimated to be performed on defects by the business and wherein the business metrics associated with operational oversight include at least one of (1) reporting compliance and (2) timeliness addressing open issues.

16. A computer program product comprising:
a non-transitory computer-readable medium comprising:
a first set of codes for causing a computing device processor to receive business metric data from a plurality of offsite service providers that provide a service for the business, wherein the business metric data covers a previous predetermined time period and includes business metrics associated with (1) personnel resourcing, (2) project delivery, (3) quality of service provided, (4) contract compliance, (5) potential risk and (6) operational oversight;
a second set of codes for causing a computing device processor to determine, for each service provider and for each business metric, a percentage of adherence to one of a predetermined service level agreement or a predetermined limit;
a third set of codes for causing a computing device processor to determine, for each service provider and for each business metric, that the percentage of adherence falls within one of a goal category, a trigger category and a limit category, wherein the goal category defines an acceptable level of adherence, the trigger category results in action on behalf of the business and the limit category results in contractual obligations; and
a fourth set of codes for causing a computing device processor to determine, for each service provider, a final performance score for the predetermined time period based on the percentage of adherence for each business metric.

17. The computer program product of claim 16, wherein the first set of codes is further configured to cause the computing device processor to receive the business metric data that includes the business metrics associated with personnel resourcing, wherein the business metrics associated with personnel resourcing include one or more of (1) amount of personnel attrition occurring over the predetermined time period, (2) amount of time to hire personnel for open positions, (3) shadow personnel resources available for identified critical personnel resources and (4) actual billing time of service provider personnel in comparison to budgeted time.

18. The computer program product of claim 16, wherein the first set of codes is further configured to cause the computing device processor to receive the business metrics associated with IT project delivery, wherein the business metrics associated with project delivery include one or more of (1) amount of projects that have been released into production without defects or issues occurring prior to release into production, (2) overall quality assurance effectiveness, (3) defects, based on defect priority, in production, (4) defects deferred to future releases, (5) defect acceptance rate, (6) coverage in regression testing, (7) successful remedial actions in comparison to all remedial actions implemented, (8) incident response time, (9) incident recovery based on defect priority, and (10) problem resolution time.

19. The computer program product of claim 16, wherein the first set of codes is further configured to cause the computing device processor to receive the business metrics associated with quality of service and contract compliance, wherein the business metrics associated with quality of service include one or more of (1) quality of software code and (2) experience of personnel resources and wherein the business metrics associated with contract compliance include one or more of (1) compliance to attrition contractual requirements, (2) ratio of onsite versus offsite personnel resources and (3) compliance with on-boarding and off-boarding contractual requirements.

20. The computer program product of claim 16, wherein the first set of codes is further configured to cause the computing device processor to receive the business metrics associated with potential risk and operational oversight, wherein the business metrics associated with potential risk include at least one of (1) cost of rework estimated to be performed on defects by the business and (2) amount of time estimated to be performed on defects by the business and wherein the business metrics associated with operational oversight include at least one of (1) reporting compliance and (2) timeliness addressing open issues.
